(19) United States
(12) Patent Application Publication
(10) Pub. No.: US 2009/0200868 A1
(43) Pub. Date: Aug. 13, 2009

(54) UNINTERRUPTIBLE POWER SUPPLY WITH RECTIFIER FAST WALK IN

(75) Inventors: John F. Christensen, Lewis Center, OH (US); Terry D. Bush, Westerville, OH (US); Mohammad N. Marwali, Lewis Center, OH (US)

Correspondence Address: HARNESS, DICKEY & PIERCE, P.L.C., P.O. BOX 828, BLOOMFIELD HILLS, MI, 48303, US

(73) Assignee: Liebert Corporation, Columbus, OH (US)

(21) Appl. No.: 12/349,689

(22) Filed: Jan. 7, 2009

Related U.S. Application Data
(60) Provisional application No. 61/028,213, filed on Feb. 13, 2008.

(51) Int. Cl. H02J 9/04

(52) U.S. Cl. 307/66

(57) ABSTRACT

In an uninterruptible power supply (“UPS”) having a flywheel storage module, switched rectifying devices of an AC/DC converter of the UPS are walked in after a utility power outage by initially firing the switched rectifying devices at a phase angle where the voltage output by the AC/DC converter to a direct current bus matches a depleted DC bus voltage. In an aspect, the initial phase angle is determined by the equation:

$$θ = 180 deg - arcsin ( \frac{VDC}{VRMS * \sqrt{2}} )$$

where θ is the initial phase angle, VDC is the depleted DC bus voltage and VRMS is the RMS voltage of the utility power.

### CROSS-REFERENCE TO RELATED APPLICATIONS

This application claims the benefit of U.S. Provisional Application No. 60/028,213, filed on Feb. 13, 2008. The entire disclosure of the above application is incorporated herein by reference.

### FIELD

The present disclosure relates generally to controlling rectifiers in an uninterruptible power supply utilizing a motor/generator/flywheel as an auxiliary DC power source.

### BACKGROUND

Referring now to FIG. 1, a functional block diagram is shown of one of several embodiments of an uninterruptible power supply (UPS) 10. In the event utility power drops out, UPS 10 provides uninterrupted power to a load, such as a computer. When the utility power drops out, the UPS 10 switches over to an auxiliary DC power source. Examples of auxiliary DC power sources include batteries, and/or motor/generator flywheels.

Where the auxiliary power source is a motor/generator flywheel, the motor/generator is driven as an electric motor when utility power is present to spin the flywheel. A motor/generator flywheel auxiliary power source may sometimes be referred to herein as a flywheel storage module. When utility power drops out, the flywheel continues to rotate for a period of time driving the motor/generator as a generator to provide auxiliary power. Typically, the flywheel rotates at the requisite speed to drive the motor/generator sufficiently to provide auxiliary power for only a short period of time, often in the order of fifteen to thirty seconds. Motor/generator flywheels are thus used in UPS to provide auxiliary power where the utility power outages are typically very short.

In UPS having motor/generator flywheels providing auxiliary power, it is important to bring the rectifiers of the UPS back into operation as quickly as possible when utility power is restored. If the UPS does not switch back to utility power quick enough, then the power to the load will be interrupted. Interruptions as brief as a few milliseconds may be enough to cause a computer load to reset and lose data.

With reference to FIG. 1, an AC/DC converter (or rectifier) 12 converts AC power from the utility to DC power. AC/DC converter 12 includes switched rectifying devices, such as silicon controller rectifiers (SCRs), triacs, thyristors, or the like. FIG. 2 shows an example of an AC/DC converter 12 that is a six pulse rectifier for three-phase rectification. AC/DC converter 12 includes three pairs of switched rectifying devices 13. A control module 18 gates the switched rectifying devices to switch them on at an appropriate firing angle in the AC cycle of the utility power. The DC power is reconverted to AC power by a DC/AC converter (or inverter) 14 and used to power the loads. In the event that the utility power drops out, AC/DC converter 12 will stop providing power and flywheel storage module 16 will begin drawing on its stored energy to replace the lost power.

Once utility power is restored, AC/DC converter 12 must be bought back into operation as quickly as possible. But AC/DC converter 12 cannot immediately be brought back into operation when utility power is restored. If the switched rectifying devices of AC/DC converter 12 are fired at a firing angle too far advanced in the AC cycle, the resulting current surge may overload the switched rectifying devices and possibly cause damage to them. Thus, AC/DC converter 12 must be brought back into operation by gradually advancing the firing angle in an orderly manner, known as rectifier walk-in.

FIGS. 3 and 4 are graphs illustrating a typical prior art rectifier walk-in at system start-up. With reference to these figures, at system start-up, the initial voltage on the DC bus is zero volts (FIG. 3) and the firing angle on the switched rectifying devices (such as SCRs) of AC/DC converter 12 is fully delayed at 180 degrees (FIG. 4). When rectifier walk-in is completed during system start-up (DC bus voltage at nominal), the firing angle of the switched rectifying devices will be advanced to a firing angle significantly less than 180 degrees, say for example 90 degrees, depending on the particular UPS design. Rectifier walk-in during system start-up takes on the order of ten seconds.

In prior art UPS having motor/generator flywheels, rectifier walk-in when utility power is restored involves firing the switched rectifying devices of the AC/DC converter at a firing angle of 180 degrees (fully delayed, conducting zero current) and then gradually decreasing (i.e., advancing) the firing angle and thus gradually increasing the current through the switched rectifying devices over a period of time. In these prior art systems, rectifier walk-in takes several seconds (typically in the five to ten second range), as shown in FIGS. 5 and 6.

### SUMMARY

This section provides a general summary of the disclosure, and is not a comprehensive disclosure of its full scope or all of its features.

In an uninterruptible power supply (“UPS”) having a flywheel storage module, switched rectifying devices of an AC/DC converter of the UPS are walked in after a utility power outage by initially firing the switched rectifying devices at a phase angle where the voltage output by the AC/DC converter to a direct current bus matches a depleted voltage on the direct current bus.

In an aspect, the initial phase is determined by the equation:

$$θ = 180 deg - arcsin ( \frac{VDC}{VRMS * \sqrt{2}} )$$

where θ is the initial phase angle, VDC is the depleted DC bus voltage and VRMS is the RMS voltage of the utility power.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of a prior art uninterruptible power supply having a flywheel storage module;

FIG. 2 is a basic schematic of an AC/DC converter of the UPS of FIG. 1;

FIGS. 3 and 4 are graphs illustrating walk-in of switched rectifying devices of a typical prior art AC/DC converter, such the AC/DC converter of FIGS. 1 and 2;

FIGS. 5 and 6 are graphs showing walk-in time of switched rectifying devices of a typical prior art AC/DC converter, such as the AC/DC converter of FIGS. 1 and 2;

FIG. 7 is a block diagram of a UPS having a flywheel storage module and rectifier walk-in in accordance with an aspect of the present disclosure; and

FIG. 8 is a graph showing DC bus voltage and rectifier walk-in for the AC/DC converter of the UPS of FIG. 7; and

FIG. 9 is a graph showing firing angle and rectifier walk-in time for the AC/DC converter of the UPS of FIG. 7.

### DETAILED DESCRIPTION

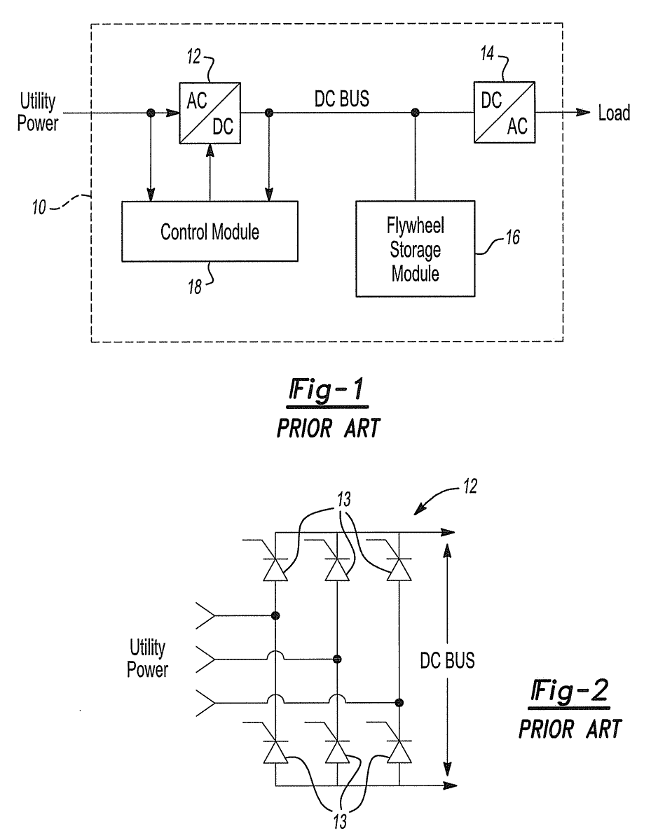

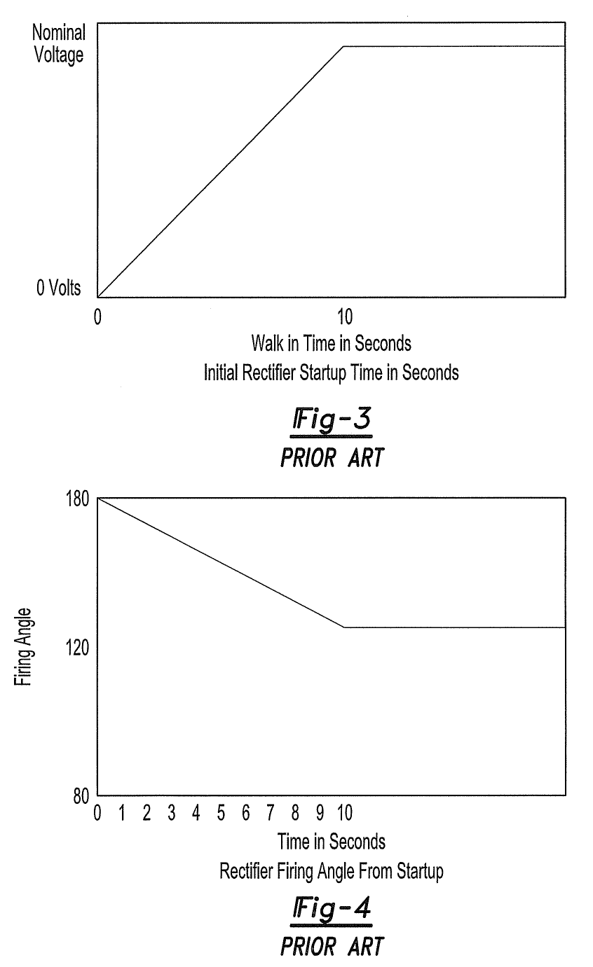

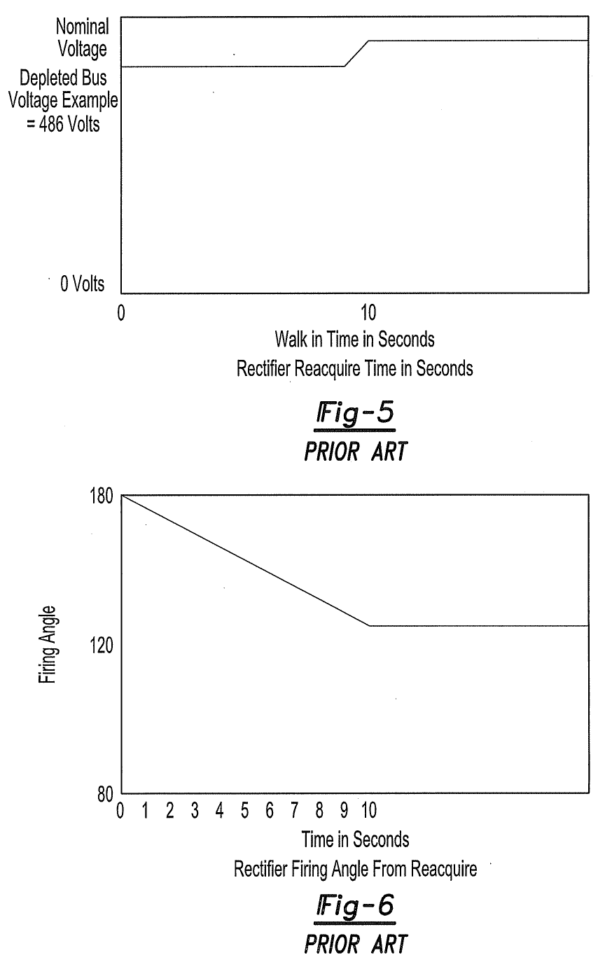

Referring now to FIG. 7, a functional block diagram is shown of a UPS 700 having improved rectifier walk-in in accordance with an aspect of the present disclosure. UPS 700 has essentially the same elements as UPS 100, except that controller 18′ is programmed to implement the improved rectifier walk-in in accordance with the present disclosure. Elements common with FIGS. 1 and 2 are identified with the same reference number. Controller 18′ is illustratively programmed to implement the walk-in of the AC/DC converter 12 in a manner than brings AC/DC converter 12 back to full operation much quicker than the prior art rectifier walk-in.

Control module 18′ may be implemented with a processor and associated computer readable memory. The processor may include analog to digital converters that digitize associated analog signals. Control module 18′ includes DC monitoring input 702 coupled to the DC bus 706. Control module 18″ also includes AC monitoring input 704 coupled to utility power feed 708.

In accordance with an aspect of the present disclosure, control module 18′ estimates the firing angle, angle θ, at which to initially fire or pre-load the switched rectifying devices of AC/DC converter 12, such as rectifying devices 13 (FIG. 2), during rectifier walk-in based on the depleted DC bus voltage and the RMS voltage of the utility power that provides the alternating current to an input of AC/DC converter 12. It should be understood that UPS 700 may have an input transformer that couples the utility power to the input of AC/DC. converter 12. In which case, the RMS voltage of the utility power used in estimating the initial phase angle could be the RMS voltage of the AC provided by the utility power source, or the RMS voltage of the AC provided by a secondary of the input transformer to which an input of the AC/DC converter is coupled. The depleted DC bus voltage is the voltage on DC bus 706 when the utility power is first restored.

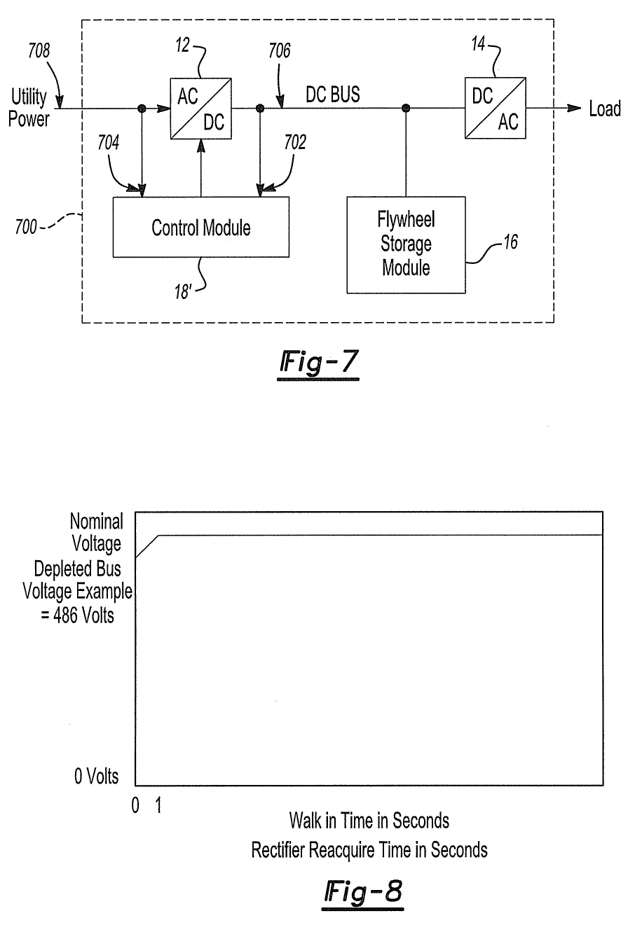

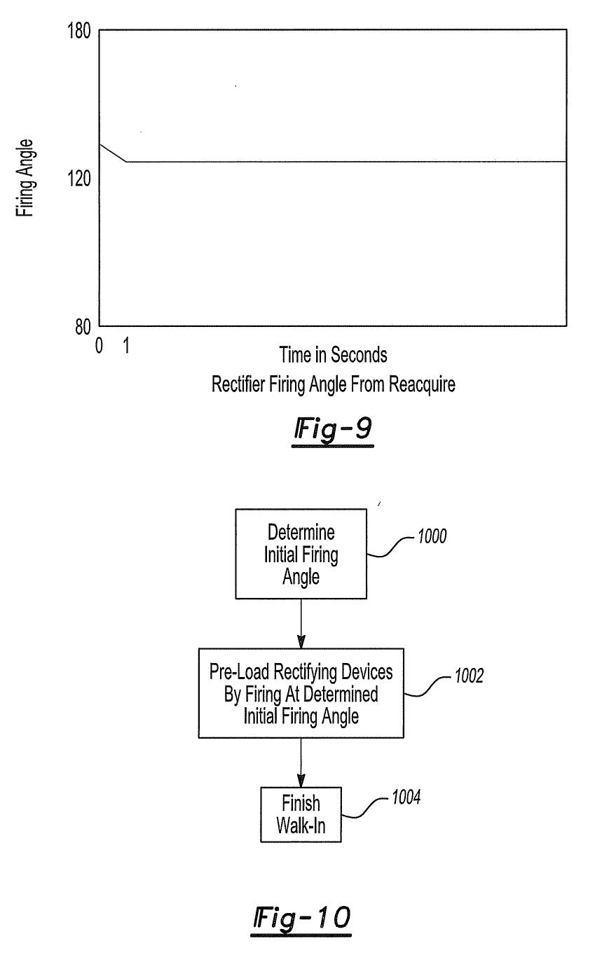

FIG. 10 is a flow chart of an illustrative control method for the improved rectifier walk-in in accordance with an aspect of the present disclosure implemented by appropriate programming of control module 18′. Utility power is restored at time T=0. At T=0, control module 18′ determines at block 1000 an initial firing angle θ. The initial firing angle θ is chosen so that the output voltage of AC/DC converter 12 matches the depleted DC bus voltage. Control module 18′ may estimate the angle θ based on the equation:

$$θ = 180 deg - arcsin ( \frac{VDC}{VRMS * \sqrt{2}} )$$

where VDC is the depleted DC bus voltage and VRMS is the RMS voltage of the utility power. At 1002, control module 18′ then pre-loads the switched rectifying devices 13 of AC/DC converter 12 by initially firing them at the estimated firing angle θ instead of at 180 degrees. At 1004, control module 18′ then continues to walk-in AC/DC converter 12 in the same manner as the prior-art walk-in. Since control module 18′ estimates angle θ at which to initially fire the switched rectifying devices of AC/DC converter 12 based on the depleted DC bus voltage and the voltage of the restored utility power so that the output voltage of AC/DC converter 12 matches the depleted DC bus voltage instead of initially firing the switched rectifying devices of AC/DC converter 12 at a firing angle of 180 degrees, control module 18′ is able to walk-in the AC/DC converter 12 much quicker than the prior art rectifier walk-in. This restores the DC bus voltage to the nominal voltage, and thus the output of UPS 700 to its nominal voltage, quicker than the prior art and reduces the risk of power to the load being interrupted while AC/DC converter 12 is being walked in. FIG. 8 is a graph showing DC bus voltage and rectifier walk-in time in accordance with the above aspect of the present disclosure and FIG. 9 is a graph showing firing angle and rectifier walk-in time in accordance with the above aspect of the present disclosure. As can be seen from FIGS. 8 and 9, rectifier walk-in time is reduced from the prior art range of five to ten seconds to about one second.

It should be understood that “matching” the depleted DC bus voltage need not be an exact match. Rather, the voltage output by the AC/DC converter can be approximately equal to the depleted DC bus voltage, such as by way of example and not of limitation ±2% of the depleted DC bus voltage.

What is claimed is:

1. An uninterruptible power supply, comprising:
an AC/DC converter that converts alternating current to direct current, the AC/DC converter having an input coupled to source of utility power that provides an alternating current, the AC/DC converter having an output coupled to a direct current bus;
a DC/AC converter having an input coupled to the direct current bus and an output coupled to an output of the uninterruptible power supply, the DC/AC converter converting direct current provided by the direct current bus to alternating current that is provided at the output of the DC/AC converter;
a flywheel storage module that provides direct current to the direct current bus upon an outage of the utility power; and
a control module that controls switched rectifying devices of the AC/DC converter, the control module walking in the switched rectifying devices after the alternating current from the source of the alternating current is restored after an outage, the control module starting walking in the switched rectifying devices after an outage by determining an initial phase angle at which to fire the switched rectifying devices at the start of the walk-in so that a voltage of the direct current provided by the AC/DC converter matches a depleted direct current bus voltage, the controller initially firing the switched rectifying devices of the AC/DC converter at the determined initial phase angle and then decreasing over time the phase angle at which it fires the switched rectifying devices until walk in of the switched rectifying devices is completed.

2. The apparatus of claim 1 wherein the control modules determines the initial phase angle based on the equation:
$$θ = 180 deg - arcsin ( \frac{VDC}{VRMS * \sqrt{2}} )$$
where θ is the initial phase angle, VDC is the depleted direct current bus voltage and VRMS is the RMS voltage of the utility power.

3. In an uninterruptible power supply having an AC/DC converter that converts alternating current of utility power provided by a source of utility power to a direct current that is provided to a direct current bus and a flywheel storage module that provides direct current to the direct current bus upon an outage of the utility power, the AC/DC converter having switched rectifying devices, a method of walking in the switched rectifying devices when the utility power is restored after an outage, comprising:
determining an initial phase angle at which to fire the switched rectifying devices at a start of the walk-in so that a voltage provided by the AC/DC converter to the direct current bus matches a depleted direct current bus voltage;
firing the switched rectifying devices at the start of the walk-in at the determined initial phase angle; and
decreasing the phase angle at which the switched rectifying devices are fired until the walk-in is completed.

4. The method of claim 3 wherein determining the initial phase angle includes determining it based on the equation:
$$θ = 180 deg - arcsin ( \frac{VDC}{VRMS * \sqrt{2}} )$$
where θ is the initial phase angle, VDC is the depleted direct current bus voltage and VRMS is the RMS voltage of the utility power.
